(19) United States
(12) Patent Application Publication
(10) Pub. No.: US 2021/0387274 A1
(43) Pub. Date: Dec. 16, 2021

(54) ELECTROLYSIS AND GRINDING COMBINED MACHINING DEVICE AND METHOD

(71) Applicant: Jiangxi University of Science and Technology, Jiangxi (CN)

(72) Inventors: Xianghe ZOU, Jiangxi (CN); Binbin SU, Jiangxi (CN); Yan LUO, Jiangxi (CN)

(73) Assignee: Jiangxi University of Science and Technology, Jiangxi (CN)

(21) Appl. No.: 17/204,672

(22) Filed: Mar. 17, 2021

(30) Foreign Application Priority Data
Jun. 12, 2020 (CN) 202010536502.1

(51) Int. Cl. B23H 5/08; B23H 5/10; B23H 7/10; B23H 7/26; B23H 7/20

(52) U.S. Cl. CPC B23H 5/08; B23H 5/10; B23H 2400/00; B23H 7/26; B23H 7/20; B23H 7/10

(57) ABSTRACT

It is provided an electrolysis and grinding combined machining device and method. The device includes a machine tool bed, a vertical moving mechanism and a horizontal moving mechanism which are provided on the machine tool bed. An electrode clamping device is provided on the vertical moving mechanism, and the electrode clamping device is configured to fix a tool electrode. An electrolysis tank is provided on the horizontal moving mechanism. A workpiece to be machined is placed in the electrolysis tank. The tool electrode includes a metal wire and abrasive materials distributed on a surface of the metal wire. The tool electrode and the workpiece to be machined are electrically connected with a pulse power source. A current sensor is arranged between the workpiece and the pulse power source. A data acquisition card is connected to the current sensor; the data acquisition card is electrically connected with an industrial personal computer.

### CROSS REFERENCE TO RELATED APPLICATION

This patent application claims the priority and benefit of Chinese Patent Application No. 202010536502.1, entitled “Electrolysis and Grinding Combined Machining Device and Method” filed with the Chinese Patent Office on Jun. 12, 2020, which is incorporated by reference herein in its entirety.

### TECHNICAL FIELD

The present invention relates to the technical field of electrochemical machining, and in particular, to an electrolysis and grinding combined machining device and method.

### BACKGROUND ART

An electrochemical machining technology is a manufacturing method for removing a metal material based on an electrochemical anode dissolution principle. During machining, a tool electrode as a cathode is connected to a negative pole of a power supply, and a hydrogen evolution reduction reaction occurs at the tool electrode. A metal workpiece as an anode is connected to a positive pole of the power supply, and an oxidation reaction occurs at the metal workpiece, so that the workpiece is dissolved and etched away in a form of ions. With continuous feeding of the tool electrode used as a cathode, a feature structure opposite to a shape of the tool electrode used as a cathode is finally formed on a surface of the workpiece. Electrochemical machining has the following advantages: no loss of a tool electrode as a cathode, negligible material hardness of a workpiece, good machining surface quality, high machining efficiency, and so on. Electrochemical machining is commonly used in the fields of aerospace, precise instruments, biomedical and the like to machine materials with complex shape and difficult to cut, such as aeronautical engine wheels, blades, microfiltration meshes, molds and the like.

In the prior art, a conventional wire electrochemical cutting generally adopts an electrode wire with a smooth surface, its machining efficiency is limited. A traditional electrochemical grinding and a traditional electrochemical milling adopt a conductive grinding wheel or a ball head with abrasive particles on the surface thereof, only for grinding machining or milling machining of surfaces. For a free abrasive electrochemical cutting, a fine abrasive material is added into electrolyte, and a passivation layer in a region to be machined is removed by a cutting force of the abrasive material, as disclosed in Chinese patent application No. CN201711142416.7, entitled “Electrochemical Cutting Machining Device with a tubular electrode having abrasive particles and multiple slots and method thereof”. With proceeding of the machining, the insoluble electrolysate is released in the electrolyte, resulting in the added abrasive material not meeting the cutting requirements. Therefore, it is necessary to frequently replace the electrolyte to ensure cutting quality.

### SUMMARY

An object of some embodiments is to provide an electrolysis and grinding combined machining device and method, which comprehensively utilizes mechanical grinding, electrochemical machining and a coupling effect between the mechanical grinding and electrochemical machining to remove materials, thereby improving machining efficiency of electrochemical cutting. The device and method utilizes abrasive materials to scrape off a passivation layer on a surface to be machined and facilitates discharge of insoluble products and gas bubbles in a narrow machining gap, thereby improving electrochemical reaction speed.

In order to achieve the above object, the present disclosure provides the following technical solutions.

It is provided an electrolysis and grinding combined machining device. The device includes a machine tool bed, a vertical moving mechanism and a horizontal moving mechanism which are provided on the machine tool bed. An electrode clamping device is provided on the vertical moving mechanism, and the electrode clamping device is configured to fix a tool electrode. The vertical moving mechanism is configured to bring the tool electrode to move up and down. An electrolysis tank is provided on the horizontal moving mechanism. The horizontal moving mechanism is configured to bring the electrolysis tank to move horizontally. Electrolyte is provided in the electrolysis tank. A workpiece to be machined is placed in the electrolysis tank. The tool electrode is configured to grind the workpiece to be machined. The tool electrode includes a metal wire and abrasive materials distributed on a surface of the metal wire.

The tool electrode and the workpiece to be machined are electrically connected with a pulse power source. The tool electrode is electrically connected to a cathode of the pulse power source, and the workpiece to be machined is connected to an anode of the pulse power source. A current sensor is arranged between the workpiece to be machined and the pulse power source. A data acquisition card is connected to the current sensor. The data acquisition card is electrically connected with an industrial personal computer.

In some embodiments, the electrolysis and grinding combined machining device further includes a motion controller which is electrically connected to the industrial personal computer, the vertical moving mechanism and the horizontal moving mechanism respectively. The motion controller controls motions of the vertical moving mechanism and the horizontal moving mechanism.

In some embodiments, the vertical moving mechanism includes a machine tool vertical support and a Z-axis moving base. The machine tool vertical support is vertically fixed on the machine tool bed. The Z-axis moving base is slidably connected with the machine tool vertical support. The electrode clamping device is fixedly connected to the Z-axis moving base.

In some embodiments, the horizontal moving mechanism includes an X-axis moving base and a Y-axis moving base. The X-axis moving base is slidably connected to the machine tool bed along an X-axis direction. The Y-axis moving base is slidably connected to the X-axis moving base along a Y-axis direction. The electrolysis tank is fixed on the Y-axis moving base. The X-axis moving base brings the electrolysis tank to move along the X-axis direction. The Y-axis moving base brings the electrolysis tank to move along the Y-axis direction.

In some embodiments, the electrolysis and grinding combined machining device further includes an oscilloscope which is electrically connected to the industrial personal computer.

In some embodiments, the abrasive materials are evenly distributed along the surface of the metal wire or distributed at intervals along a radial direction and an axial direction of the metal wire.

In some embodiments, a fixing bracket is provided in the electrolysis tank, and the fixing bracket is configured for fixing the workpiece to be machined.

It is also provided an electrolysis and grinding combined machining method according to the present disclosure, which uses the electrolysis and grinding combined machining device. The method includes the following steps:

immersing the workpiece to be machined in electrolyte, and electrochemically dissolve the workpiece to be machined for a predetermined time;

controlling the tool electrode to reciprocally move up and down for travelling the metal wire;

acquiring a current signal during machining in real time, comparing the current signal with a predetermined current threshold upon a stable machining state is reached, increasing a speed at which the tool electrode reciprocally moves up and down to travel the metal wire rapidly, so as to rapidly scrape off a passivation layer on a surface of the workpiece by utilizing abrasive materials on a surface of the tool electrode, when the current signal is lower than the predetermined current threshold, which indicates that the electrochemical reaction becomes slow due to the passivation layer; controlling the speed of the tool electrode to reduce back to a previous speed for travelling the metal wire, when the current signal is higher than the set current threshold.

In some embodiments, the method further includes controlling movement of the tool electrode in an X-axis and a Y-axis, to electrolyze and grind the workpiece to be machined into a product with a specific shape structure.

According to the specific embodiments provided by the present disclosure, the present disclosure provides the following technical effects: the electrolysis and grinding combined machining device and method according to the present disclosure provides a vertical moving mechanism to bring the tool electrode to move up and down for travelling the metal wire, and provides a horizontal moving mechanism for machining a shape of the workpiece to be machined. Further, automation level and efficiency of electrochemical cutting machining is improved by monitoring a machining current through a current sensor in time and performing a feedback control. Mechanical grinding, electrochemical machining and a coupling effect between the mechanical grinding and electrochemical machining are comprehensively utilized to remove materials, thereby improving machining efficiency of electrochemical cutting. The tool electrode utilizes a metal wire with abrasive materials adhered to the surface thereof, the abrasive materials may scrape off a passivation layer on a machining surface, thus a travelling wire speed of the tool electrode may be improved, i.e. a travelling wire speed when the mechanical grinding is performed is greater than that when the electrolysis is performed, and discharge of insoluble products and gas bubbles in a narrow machining gap is facilitated, thereby improving electrochemical reaction speed. Compared with free abrasive material cutting, there is no abrasive material in the electrolyte, and the electrolyte can be recycled through a filter system, which is energy-saving and environmentally friendly.

### BRIEF DESCRIPTION OF THE DRAWINGS

In order to describe the technical solutions in the embodiments of the present disclosure or in the prior art more clearly, the accompanying drawings involved in the embodiments will be briefly described below. Apparently, the accompanying drawings in the following description are merely some embodiments of the present disclosure, and for a person of ordinary skill in the art, other accompanying drawings can be obtained according to these accompanying drawings without paying creative efforts.

FIG. 1 is a structural schematic diagram of an electrolysis and grinding combined machining device according to an embodiment of the present disclosure; and

FIG. 2 is a structural schematic diagram of a tool electrode of the present disclosure;

FIG. 3 is a schematic diagram showing an electrolysis and grinding combined machining principle according to the present disclosure.

List of reference numbers: 1 machine tool bed; 2 machine tool vertical support; 3 Z-axis moving base; 4 electrode clamping device; 5 tool electrode; 501 metal wire; 502 abrasive material; 6 pulse power supply; 7 motion controller; 8 industrial personal computer; 9 oscilloscope; 10 data acquisition card; 11 current sensor; 12 electrolysis tank; 13 Y-axis moving base; 14 X-axis moving base; 15 workpiece to be machined; 16 fixing bracket.

### DETAILED DESCRIPTION OF THE EMBODIMENTS

The technical solutions in the embodiments of the present disclosure will be clearly and completely described below in conjunction with the accompanying drawings in the embodiments of the present disclosure. Apparently, the described embodiments are only a part of the embodiments of the present disclosure, rather than all of the embodiments. Based on the embodiments of the present disclosure, all other embodiments obtained by those of ordinary skill in the art without paying creative efforts, shall fall within the protection scope of the present disclosure.

An object of some embodiments is to provide an electrolysis and grinding combined machining device and method, which comprehensively utilizes mechanical grinding, electrochemical machining and a interaction between the mechanical grinding and the electrochemical machining to remove material, thereby improving machining efficiency of electrochemical cutting; and the device and method utilizes abrasive materials to scrape off a passivation layer on a machining surface and facilitate discharge of insoluble products and gas bubbles in a narrow machining gap, thereby improving electrochemical reaction rate.

In order to make the above objectives, features and advantages of the present disclosure more apparent and understandable, the present disclosure will be further described in detail below with reference to the accompanying drawings and specific embodiments.

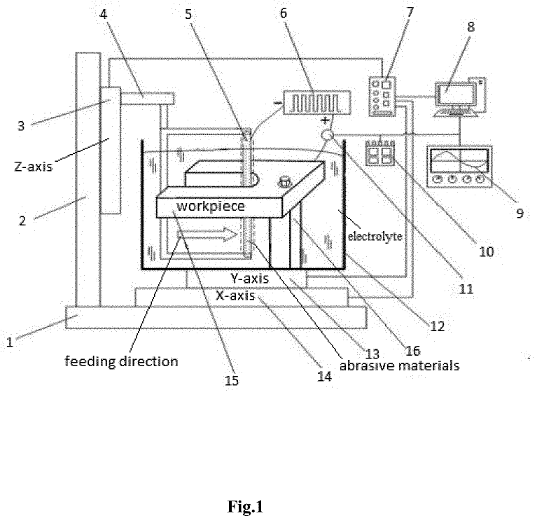

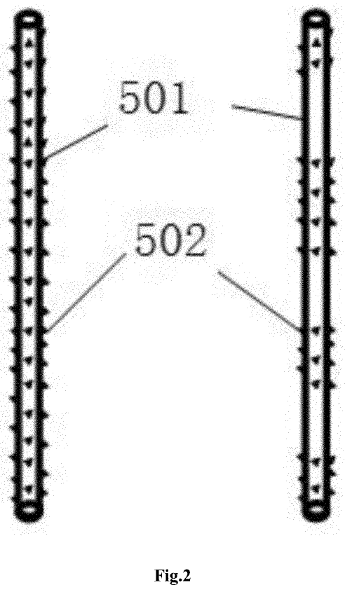

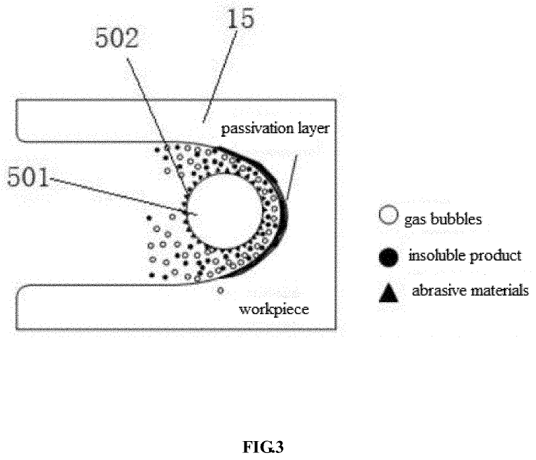

As shown in FIG. 1, it is provided an electrolysis and grinding combined machining device. The device includes a machine tool bed 1, a vertical moving mechanism and a horizontal moving mechanism which are provided on the machine tool bed 1. An electrode clamping device 4 is provided on the vertical moving mechanism, and the electrode clamping device 4 is configured for fixing a tool electrode 5. The vertical moving mechanism is configured to bring the tool electrode to move up and down. An electrolysis tank 12 is provided on the horizontal moving mechanism. The horizontal moving mechanism is configured to bring the electrolysis tank 12 to move horizontally. Electrolyte is provided in the electrolysis tank 12. A workpiece 15 to be machined is placed in the electrolysis tank 12. The workpiece 15 to be machined is fixed in the electrolysis tank 12 by a fixing bracket 16. As shown in FIG. 3, the tool electrode 5 is configured to grind the workpiece 15 to be machined. The tool electrode 5 includes a metal wire 501 and abrasive materials 502 distributed on a surface of the metal wire, as shown in FIG. 2.

The tool electrode 5 and the workpiece 15 to be machined are electrically connected with a pulse power source 6. The tool electrode 5 is connected to a cathode of the pulse power source 6, and the workpiece 15 to be machined is connected to an anode of the pulse power source 6. A current sensor 11 is arranged between the workpiece 15 to be machined and the pulse power source 6. A data acquisition card 10 is connected to the current sensor. The data acquisition card 10 is electrically connected with an industrial personal computer 8.

In some embodiments, the electrolysis and grinding combined machining device further includes a motion controller 7 which is electrically connected to the industrial personal computer 8, the vertical moving mechanism and the horizontal moving mechanism respectively. The motion controller 7 controls motion of the vertical moving mechanism and the horizontal moving mechanism.

The vertical moving mechanism includes a machine tool vertical support 2 and a Z-axis moving base 3. The machine tool vertical support 2 is vertically fixed on the machine tool bed 1. The Z-axis moving base 3 is slidably connected with the machine tool vertical support 2. The electrode clamping device 4 is fixedly connected to the Z-axis moving base 3.

The horizontal moving mechanism includes an X-axis moving base 14 and a Y-axis moving base 13. The X-axis moving base 14 is slidably connected to the machine tool bed 1 along an X-axis direction. The Y-axis moving base 13 is slidably connected to the X-axis moving base 14 along a Y-axis direction. The electrolysis tank 12 is fixed on the Y-axis moving base 13. The X-axis moving base 14 brings the electrolysis tank 12 to move along the X-axis direction. The Y-axis moving base 13 brings the electrolysis tank 12 to move along the Y-axis direction.

The electrolysis and grinding combined machining device further includes an oscilloscope 9 which is electrically connected to the industrial personal computer 8.

As shown in FIG. 2, the abrasive materials 502 are evenly distributed on a surface of the metal wire 501, or distributed at intervals along a radial direction and an axial direction of the metal wire 501. A metal wire with the abrasive materials adhered to the surface thereof is used as the tool electrode, surfaces of the abrasive materials are non-conductive and the metal wire is conductive.

It is also provided an electrolysis and grinding combined machining method by the present disclosure, which uses the electrolysis and grinding combined machining device. The method includes the following steps:

immersing the workpiece to be machined in the electrolyte, electrochemically dissolve the workpiece to be machined for a predetermined time;

controlling the tool electrode to reciprocally move up and down for travelling the metal wire;

acquiring a current signal during machining in real time, comparing the current signal with a predetermined current threshold, upon a stable machining state is reached; increasing a speed at which the tool electrode reciprocally moves up and down to travel the metal wire rapidly so as to rapidly scrape off a passivation layer on the surface of the workpiece by abrasive materials on a surface of the tool electrode, when the current signal is lower than the predetermined current threshold, which indicates that the electrochemical reaction becomes slow due to the passivation layer; controlling the speed of the tool electrode to reduce back to the previous speed for travelling the metal wire, when the current signal is higher than the predetermined current threshold.

In some embodiments, the method further includes controlling movement of the tool electrode in the X-axis direction and the Y-axis direction, to electrolyze and grind the workpiece to be machined into a product with a specific shape structure.

An area of the workpiece which is to be machined is immersed in electrolyte. During the machining, it can be considered that electrolysis and mechanical grinding are performed alternately. Due to the electrolysis, the machined area of the workpiece is electrochemically dissolved. After undergoing the dissolution for a certain time, the surface of the workpiece has a passivation layer formed thereon. The formed passivation layer affects an electrochemical reaction rate, and even in a severe case hinders the electrochemical machining from being performed. Through moving the tool electrode up and down for travelling the wire, the abrasive materials attached to the surface of the tool electrode scrape off the passivation layer, to enable a new surface of the workpiece to be exposed, for proceeding to the electrochemical machining, and in turn continuously performing the combined machining. A relative movement of the workpiece along an X-axis direction and a Y-axis direction is controlled by a motion controller, to obtain a specific structure through the electrolysis and grinding combined machining.

In the electrolysis and grinding combined machining device and method according to the present disclosure, a vertical moving mechanism is provided for bringing a tool electrode to move up and down for travelling the wire, and a horizontal moving mechanism is provided for machining a shape of a workpiece to be machined. Automation level and efficiency of electrochemical cutting machining is improved by monitoring a machining current through a current sensor in time and performing a feedback control. The mechanical grinding, electrochemical machining and a coupling effect between the mechanical grinding and electrochemical machining are comprehensively utilized to remove materials, thereby improving machining efficiency of electrochemical cutting. The tool electrode utilizes a metal wire with abrasive materials adhered to the surface thereof, the abrasive materials may scrape off the passivation layer on a machining surface, a travelling wire speed by the tool electrode may be improved, i.e. a travelling wire speed when the mechanical grinding is performed is greater than that when the electrolysis is performed, and discharge of insoluble products and gas bubbles in a narrow machining gap is facilitated, thereby improving electrochemical reaction speed. Compared with free abrasive material cutting, there is no abrasive material in the electrolyte, and the electrolyte can be recycled through a filter system, which is energy-saving and environmentally friendly.

Specific examples are used in the present disclosure to describe the principles and implementations of the present disclosure. The description of the above embodiments is only used to help understand the method and core idea of the present disclosure; furthermore, for those skilled in the art, according to the idea of the present disclosure, there will be changes in the specific implementations and the application scope. In summary, the content of this specification should not be construed as a limitation of the present disclosure.

What is claimed is:

1. An electrolysis and grinding combined machining device, comprising:
a machine tool bed, a vertical moving mechanism and a horizontal moving mechanism which are provided on the machine tool bed, wherein an electrode clamping device is provided on the vertical moving mechanism, and the electrode clamping device is configured to fix a tool electrode;
the vertical moving mechanism is configured to bring the tool electrode to move up and down;
an electrolysis tank is provided on the horizontal moving mechanism;
the horizontal moving mechanism is configured to bring the electrolysis tank to move horizontally;
electrolyte is provided in the electrolysis tank;
a workpiece to be machined is placed in the electrolysis tank;
the tool electrode is configured to grind the workpiece to be machined;
the tool electrode comprises a metal wire and abrasive materials distributed on a surface of the metal wire;
the tool electrode and the workpiece to be machined are electrically connected with a pulse power source;
the tool electrode is connected to a cathode of the pulse power source, and the workpiece to be machined is connected to an anode of the pulse power source;
a current sensor is arranged between the workpiece to be machined and the pulse power source;
a data acquisition card is connected to the current sensor;
the data acquisition card is electrically connected with an industrial personal computer.

2. The device according to claim 1, wherein the electrolysis and grinding combined machining device further comprises a motion controller which is electrically connected to the industrial personal computer, the vertical moving mechanism and the horizontal moving mechanism respectively; the motion controller controls motions of the vertical moving mechanism and the horizontal moving mechanism.

3. The device according to claim 1, wherein the vertical moving mechanism comprises a machine tool vertical support and a Z-axis moving base, the machine tool vertical support is vertically fixed on the machine tool bed; the Z-axis moving base is slidably connected with the machine tool vertical support; the electrode clamping device is fixedly connected to the Z-axis moving base.

4. The device according to claim 1, wherein the horizontal moving mechanism comprises an X-axis moving base and a Y-axis moving base; the X-axis moving base is slidably connected to the machine tool bed along an X-axis direction, the Y-axis moving base is slidably connected to the X-axis moving base along a Y-axis direction; the electrolysis tank is fixed on the Y-axis moving base; the X-axis moving base brings the electrolysis tank to move along the X-axis direction; the Y-axis moving base brings the electrolysis tank to move along the Y-axis direction.

5. The device according to claim 1, wherein the electrolysis and grinding combined machining device further comprises an oscilloscope which is electrically connected to the industrial personal computer.

6. The device according to claim 1, wherein the abrasive materials are evenly distributed along a surface of the metal wire or distributed at intervals along a radial direction and an axial direction of the metal wire.

7. The device according to claim 1, wherein a fixing bracket is provided in the electrolysis tank, and the fixing bracket is configured for fixing the workpiece to be machined.

8. An electrolysis and grinding combined machining method using the electrolysis and grinding combined machining device according to any one of the previous claims 1-7, comprising the following steps:
immersing the workpiece to be machined in electrolyte, electrochemically dissolve the workpiece to be machined for a predetermined time;
controlling the tool electrode to reciprocally move up and down for travelling the metal wire;
acquiring a current signal during machining in real time, comparing the current signal with a predetermined current threshold upon a stable machining state is reached, increasing a speed at which the tool electrode reciprocally moves up and down to travel the metal wire rapidly, so as to rapidly scrape off a passivation layer on a surface of the workpiece by utilizing abrasive materials on a surface of the tool electrode, when the current signal is lower than the predetermined current threshold, which indicates that the electrochemical reaction becomes slow due to the passivation layer, controlling the speed of the tool electrode to reduce back to a previous speed for travelling the metal wire, when the current signal is higher than the set current threshold.

9. The method according to claim 8, wherein the method further includes controlling movement of the tool electrode in an X-axis and a Y-axis, to electrolyze and grind the workpiece to be machined into a product with a specific shape structure.
